(19) United States
(12) Patent Application Publication
(10) Pub. No.: US 2024/0413753 A1
(43) Pub. Date: Dec. 12, 2024

(54) DC/DC CONVERTER USING ADAPTIVE CONTROLLER FOR MAXIMUM EFFICIENCY UNDER DYNAMIC LOAD CONDITIONS

(71) Applicant: FADU Inc., Seoul (KR)

(72) Inventors: Kichang JANG, Seoul (KR); Jungeui PARK, Suwon-si (KR); Jaeil LEE, Gwangmyeong-si (KR); Kwanseok JUNG, Seoul (KR)

(73) Assignee: FADU Inc., Seoul (KR)

(21) Appl. No.: 18/735,832

(22) Filed: Jun. 6, 2024

Related U.S. Application Data
(60) Provisional application No. 63/471,537, filed on Jun. 7, 2023.

(30) Foreign Application Priority Data
Jun. 7, 2023 (KR) 10-2023-0072644

(51) Int. Cl. H02M 3/158; H02M 1/00; H02M 1/088

(52) U.S. Cl. CPC H02M 3/1582; H02M 1/0054; H02M 1/088

(57) ABSTRACT

Disclosed is a DC/DC converter using an adaptive controller for maximum efficiency under dynamic load conditions. The DC/DC converter includes N power switches, each of which has a size of 1/N such that their device size is maintained the same as that of power switches of a conventional DC/DC converter. The use of the adaptive controller in the DC/DC converter can achieve maximum efficiency under dynamic load conditions by varying the number of power switches driven depending on load currents.

### CROSS REFERENCE TO RELATED APPLICATIONS

This application claims the benefit under 35 USC 119 (e) of U.S. Provisional Application No. 63/471,537 filed on Jun. 7, 2023, and claims the benefit under 35 USC 119 (a) and 365 (b) of Korean Patent Application No. 10-2023-0072644, filed on Jun. 7, 2023, in the Korean Intellectual Property Office, the entire disclosure of which is incorporated herein by reference for all purposes.

### BACKGROUND OF THE INVENTION

### 1. Field of the Invention

The present invention relates to a DC/DC converter using an adaptive controller for maximum efficiency under dynamic load conditions. More specifically, the present invention relates to a DC/DC converter in which the number of power switches is adjusted depending on load conditions such that conduction loss and switching loss are minimized.

### 2. Description of the Related Art

DC/DC converters are circuits that step down a higher DC voltage to a lower DC voltage or, conversely, boost a lower DC voltage to a higher DC voltage. Such converters are very important components in the electronics industry and are used as power and battery charging circuits for computers, power tools, TVs, media tablets, smartphones, automobiles, and various other electrical/electronic devices. DC/DC converters are classified into boost converters boosting a DC input voltage and buck converters stepping down a DC input voltage.

FIG. 1 illustrates the structures of (A) a conventional buck converter and (B) a conventional boost converter. In the buck converter, two power switches rds1 and rds2 are connected between an input end and a ground end and an inductor and a capacitor are connected to an output end that is electrically connected to a node to which the power switches are connected. In the boost converter, two power switches rds1 and rds2 are connected between an output end and a ground end, an inductor is connected to an input end that is electrically connected to a node to which the power switches are connected, and a capacitor is connected to the output end.

A DC/DC converter controls an output voltage to a desired voltage value through ON/OFF operations of power switches. The voltage control uses pulse width modulation (PWM) or pulse frequency modulation (PFM) mode. According to PWM mode, ON/OFF operations of power switches are controlled with constant switching frequencies, that is, constant switching cycles, the duty ratio of the power switches is determined depending on an input voltage and an output voltage, and switching operations are performed with pulse widths according to the duty ratio to control the output voltage. According to PFM mode, an output voltage is controlled by varying the operating frequencies of power switches depending on an input voltage and the output voltage of a DC/DC converter. Generally, power switches operate with varying frequencies depending on load currents at fixed on-time pulse-widths.

In DC/DC converters, power loss is due to conduction loss and switching loss. Conduction loss refers to power loss caused by currents flowing in power switches and resistance generated when power switches are turned ON. Conduction loss is independent of operating frequency and is proportional to the square of load current. Switching loss refers to power loss caused by repeated ON/OFF switching operations of power switches and is proportional to operating frequency and the total gate capacitance of power switches.

Under heavy load conditions, conduction loss is a dominant factor due to high current. Under light load conditions, switching loss is a dominant factor due to low current. For optimum power efficiency under different load conditions, DC/DC converters generally use PWM mode under heavy load conditions and PFM mode under light load conditions.

However, even these control modes have limitations in minimizing switching loss because the total gate capacitance of power switches whose device size is determined is fixed and have difficulties in achieving maximum efficiency in response to various load current conditions during the operation of converters.

Thus, there is an urgent need for a solution to the problem of power loss in conventional DC/DC converters.

### SUMMARY OF THE INVENTION

The present invention has been made in an effort to solve the problems of the prior art and is intended to provide a DC/DC converter which includes N power switches, each of which has a size of 1/N such that their device size is maintained the same as that of power switches of a conventional DC/DC converter, and in which the number of power switches driven depending on load currents varies, achieving maximum efficiency under dynamic load conditions.

A DC/DC converter according to an embodiment of the present invention is designed to boost or step down an input voltage applied to one of a first input/output end and a second input/output end and to output an output voltage through the other input/output end and includes: a switch unit including N (N is a natural number greater than or equal to 2) switch strings, each of which includes a first power switch and a second power switch alternately turned ON and OFF and connected in series with each other, arranged such that the N first power switches are connected in parallel between the first input/output end and a node and the N second power switches are connected in parallel between the node and a ground end; a switching operation control unit independently controlling switching operations of the first power switches and the second power switches; and a switch activation unit controlling switch activation such that only the switches of K (K is a natural number from 2 to N) ones of the N switch strings are operated based on a switch current value corresponding to the sum of current values flowing through the first power switches and the second power switches in a switching cycle where the first power switches and the second power switches are alternately turned ON and OFF.

Between a first switching cycle and a second switching cycle that are performed sequentially and continuously, the switch activation unit may perform the second switching cycle in which the number of the switching strings whose switches are activated is increased compared to that in the first switching cycle when the switch current value in the first switching cycle exceeds a predetermined first threshold or perform the second switching cycle in which the number of the switching strings whose switches are activated is decreased compared to that in the first switching cycle when the switch current value in the first switching cycle is less than a predetermined second threshold.

Only one switch string may be decreased or increased.

When the switch current value in the first switching cycle is not higher than the first threshold and not lower than the second threshold, the second switching cycle may be performed in a state in which the number of the switch strings whose switches are activated in the first switching cycle is maintained.

Each of the first power switches may include a P-channel MOSFET, each of the second power switches may include an N-channel MOSFET, and the switching operation control unit may include a gate driver.

The switch activation unit may be operated in pulse width modulation (PWM) mode.

The features and advantages of the present invention will become apparent from the following description with reference to the accompanying drawings.

Prior to the detailed description of the invention, it should be understood that the terms and words used in the specification and the claims are not to be construed as having common and dictionary meanings but are construed as having meanings and concepts corresponding to the technical spirit of the present invention in view of the principle that the inventor can define properly the concept of the terms and words in order to describe his/her invention with the best method.

The DC/DC converter of the present invention uses an adaptive controller to adjust the number of power switches that are operated variably depending on the magnitude of load current. Therefore, the number of operating power switches can be increased under heavy load conditions to reduce conduction loss, which constitutes a large portion of power loss, and can be decreased under light load conditions to minimize switching loss, achieving maximum efficiency under dynamic load current conditions.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structures of (A) a conventional buck converter and (B) a conventional boost converter;

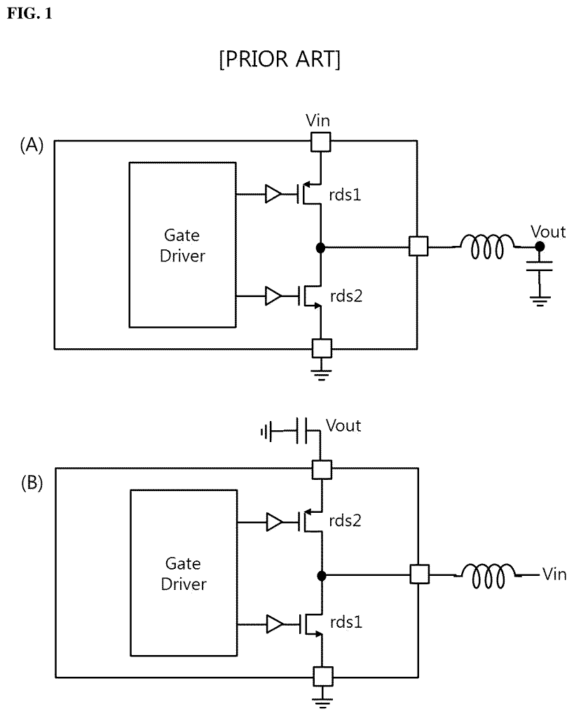

FIG. 2 schematically illustrates the construction of a DC/DC converter according to an embodiment of the present invention;

FIG. 3 illustrates a state in which a DC/DC converter according to an embodiment of the present invention operates under heavy load conditions;

FIG. 4 illustrates a state in which a DC/DC converter according to an embodiment of the present invention operates under light load conditions;

FIG. 5 is a flowchart illustrating the operation of a DC/DC converter according to an embodiment of the present invention;

FIG. 6 illustrates (A) a conventional buck converter and shows (B) power loss and efficiency of the conventional buck converter depending on load current; and

FIG. 7 illustrates (A) a DC/DC converter according to an embodiment of the present invention and shows (B) power loss and efficiency of the DC/DC converter depending on load current.

### DETAILED DESCRIPTION OF THE INVENTION

The objects, specific advantages, and novel features of the present invention will become apparent from the following detailed description and preferred embodiments in conjunction with the accompanying drawings. It should be noted that in the drawings, the same components are denoted by the same reference numerals even though they are depicted in different drawings. Although such terms as “first” and “second,” etc. may be used to describe various components, these components should not be limited by above terms. These terms are used only to distinguish one component from another. In the description of the present invention, detailed explanations of related art are omitted when it is deemed that they may unnecessarily obscure the essence of the present invention.

Preferred embodiments of the present invention will now be described in detail with reference to the accompanying drawings.

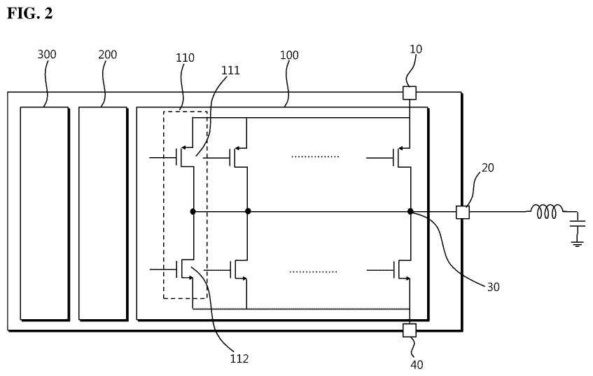

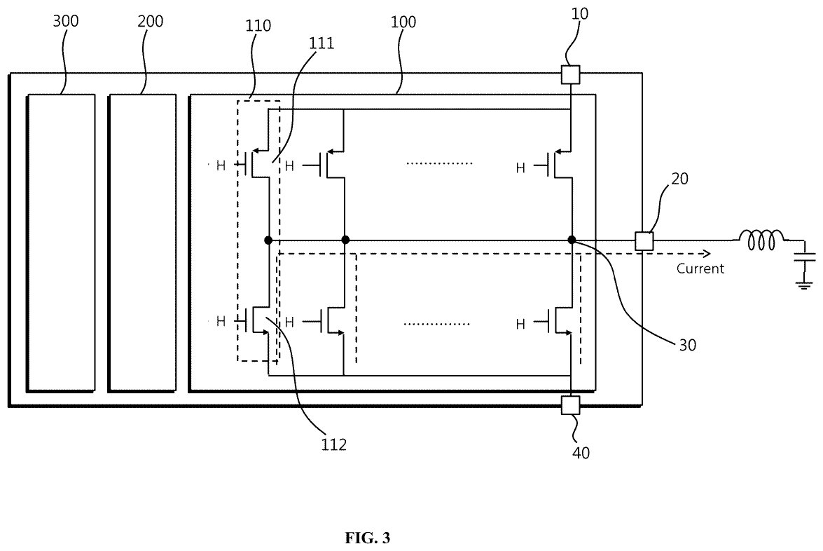

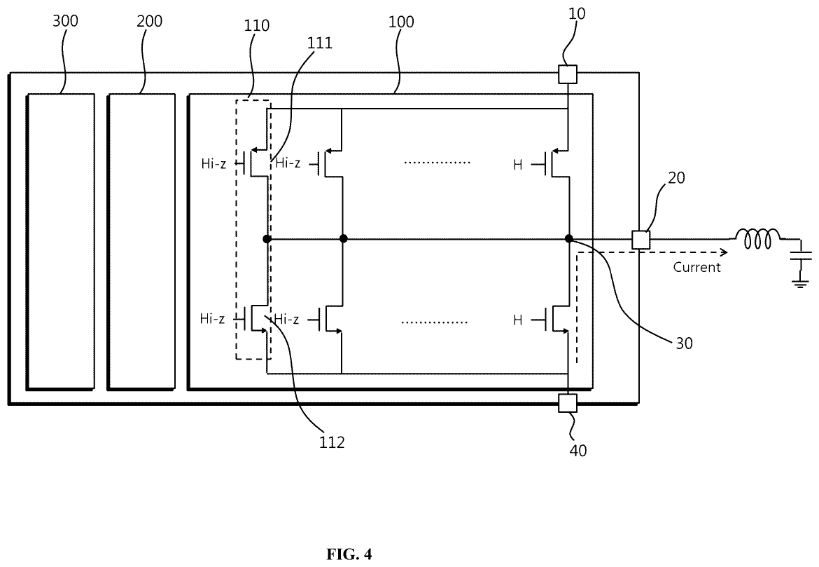

FIG. 2 schematically illustrates the construction of a DC/DC converter according to an embodiment of the present invention, FIG. 3 illustrates a state in which the DC/DC converter operates under heavy load conditions, and FIG. 4 illustrates a state in which the DC/DC converter operates under light load conditions.

As illustrated in FIG. 2, the DC/DC converter is designed to boost or step down an input voltage applied to one of a first input/output end 10 and a second input/output end 20 and to output an output voltage through the other input/output end and includes: a switch unit 100 including N (N is a natural number greater than or equal to 2) switch strings 110, each of which includes a first power switch 111 and a second power switch 112 alternately turned ON and OFF and connected in series with each other, arranged such that the N first power switches 111 are connected in parallel between the first input/output end 10 and a node 30 and the N second power switches 112 are connected in parallel between the node 30 and a ground end 40; a switching operation control unit 200 independently controlling switching operations of the first power switches 111 and the second power switches 112; and a switch activation unit 300 controlling switch activation such that only the switches of K (K is a natural number from 2 to N) ones of the N switch strings 10 are operated based on a switch current value corresponding to the sum of current values flowing through the first power switches 111 and the second power switches 112 in a switching cycle where the first power switches 111 and the second power switches 112 are alternately turned ON and OFF.

The DC/DC converter of the present invention achieves maximum efficiency under dynamic load conditions. In contrast, conventional DC/DC converters designed to control an output voltage through ON/OFF operations of two power switches connected in series with each other have limitations in minimizing switching loss because the total gate capacitance of the power switches whose device size is determined is fixed and have difficulties in achieving maximum efficiency in response to various load current conditions during operation. The present invention has been devised as a solution to these limitations and difficulties.

Power loss of a DC/DC converter is due to conduction loss caused by currents flowing in power switches and resistance generated when power switches are turned ON and switching loss caused by repeated ON/OFF switching operations of power switches. In the DC/DC converter of the present invention, the number of power switches is adjusted depending on dynamically changing heavy load or light load conditions to minimize conduction loss and switching loss, achieving maximum efficiency.

Specifically, the DC/DC converter of the present invention is a circuit that steps down or boosts an input voltage applied to one of a first input/output end 10 and a second input/output end 20 and to output an output voltage to the other input/output end. As described above, the DC/DC converter includes a switch unit 100, a switching operation control unit 200, and a switch activation unit 300. The DC/DC converter includes may be a boost converter boosting a DC input voltage and a buck converter stepping down a DC input voltage.

The switch unit 100 includes N (Nis a natural number greater than or equal to 2) switch strings 110. Each of the N (Nis a natural number greater than or equal to 2) switch strings 110 includes a first power switch 111 and a second power switch 112. The first power switch 111 and the second power switch 112 are connected in series with a node 30. The first power switch 111 and the second power switch 112 are alternately turned ON and OFF to generate an output voltage. That is, when the first power switch 111 is turned ON and OFF, the second power switch 112 is turned OFF and ON, respectively. As a result of this switching operation, an input voltage is boosted or stepped down.

Since the number of the switch strings 110 is N, the first power switches 111 are provided in N and the second power switches 112 are provided in N in the switch unit 100. The N first power switches 111 are connected in parallel between a first input end and a node 30 and the N second power switches 112 are connected in parallel between the node 30 and a ground end 40. The node 30 is electrically connected to a second input/output end 20.

The switching operation control unit 200 independently controls switching operations of the first power switches 111 and the second power switches 112. For example, each of the first power switches 111 includes a P-channel MOSFET, each of the second power switches 112 includes an N-channel MOSFET, and the switching operation control unit 200 includes a gate driver electrically connected to the first power switches 111 and the second power switches 112. When the gate driver applies a gate voltage Vos to charge a gate capacitor, the first power switches 111 and the second power switches 112 are turned ON. When the gate capacitor is discharged, the first power switches 111 and the second power switches 112 are turned OFF.

The switch activation unit 300 controls switch activation such that only the switches of K (K is a natural number greater than or equal to 2) ones of the N switch strings 110 are operated. Accordingly, switching operations are performed only in the switch-activated ones of the N switch strings. For example, assuming that the total number of the switch strings 110 is 10, the switch activation unit 300 performs switch activation such that only three of the switch strings 110 operate, with the result that only the first power switches 111 and the second power switches 112 of the three switch strings 110 whose switches are activated can perform switching operations. The switch activation unit 300 may transmit a control signal to the switching operation control unit 200 to prevent operation of the switch strings 110 whose switches are deactivated. For example, the switch activation unit 300 places the gates of the MOSFETs constituting the first power switches 111 and the second power switches 112 in high impedance states to deactivate the corresponding switch strings 110.

The switch activation is controlled based on a switch current value corresponding to the sum of a first current value flowing through the turned-on first power switches and a second current value flowing through the turned-on second power switches. The switch current value is calculated for each switching cycle. Depending on a switch current value calculated for a specific switching cycle, the number of the switch strings 110 whose switches are to be activated in a subsequent switching cycle is determined. As used herein, the term “switching cycle” refers to a series of processes for switching operations in which the second power switches 112 are turned OFF when the first power switches 111 are turned ON and the second power switches 112 are turned ON when the first power switches 111 are turned OFF.

The switch activation may be performed in pulse width modulation (PWM) mode. According to pulse width modulation mode, the switching operations of the first power switches 111 and the second power switches 112 are controlled with constant switching frequencies, that is, constant switching cycles, the duty ratio of the power switches is determined depending on an input voltage and an output voltage, and switching operations are performed with pulse widths according to the duty ratio to control the output voltage. Therefore, the DC/DC converter of the present invention may further include an oscillator and a PWM controller to perform pulse width modulation mode. In addition, the DC/DC converter of the present invention may further include a PFM controller to control switching operations of the first power switches 111 and the second power switches 112 in pulse frequency modulation (PFM) mode. The oscillator, the PWM controller, and the PFM controller are constructed to perform the control mode of DC/DC converters. This construction is known in the art, and hence a detailed description thereof is omitted herein.

The operation of the switch activation unit under heavy or light load conditions will be described in more detail.

With reference to FIG. 3, under heavy load conditions where driving load currents are high, the switch activation unit can activate the switches of all N switch strings 110 to minimize conduction loss.

With reference to FIG. 4, under light load conditions where driving load currents are low, the switch activation unit 300 can activate only the switches of some of the N switch strings 110 and deactivate the switches of the remaining switch strings 110 to minimize switching loss. At this time, the gates of the first deactivated power switches 111 and the second deactivated power switches 112 of the switch strings 110 may be in high impedance (Hi-z) states.

Not all N switch strings 110 necessarily operate under heavy load conditions. The heavy load conditions and the light load conditions are relatively determined. Thus, between first and second switching cycles that are performed sequentially and continuously, the number of the switch strings 110 to be operated in the second switching cycle can be increased or decreased depending on load conditions of the first switching cycle.

That is, when the switch current value in a first switching cycle exceeds a predetermined first threshold, a second switching cycle can be performed in which the number of the switch strings 110 where the switches are activated is increased compared to that in the first switching cycle. When the switch current value in a first switching cycle is less than a predetermined second threshold, a second switching cycle can be performed in which the number of the switch strings 110 where the switches are activated is decreased compared to that in the first switching cycle. Here, only one switch string 110 may be decreased or increased.

For example, in the case where the switches of five of the switch strings 110 are activated and operated in a first switching cycle, a switch current value is calculated by summing current values flowing through the first power switches 111 and the second power switches 112 of each of the five switch strings 110 and the switch activation unit 300 compares the switch current value with a predetermined first threshold. When the switch current value exceeds the first threshold, the switch activation unit 300 activates the switches of one additional switch string 110, with the result that a total of six switch strings 110 can operate in a second switching cycle.

As another example, in the case where the switches of five of the switch strings 110 are activated and operated in a first switching cycle, a switch current value is calculated by summing current values flowing through the first power switches 111 and the second power switches 112 of each of the five switch strings 110 and the switch activation unit 300 compares the switch current value with a predetermined second threshold. When the switch current value is less than the second threshold, the switch activation unit 300 deactivates the switches of one of the switch strings 110, with the result that only a total of four switch strings 110 can operate in a second switching cycle.

Here, when the switch current value calculated in the first switching cycle is not higher than the first threshold and is not lower than the second threshold, the number of the switch strings 110 whose switches are activated in the first switching cycle can also be maintained in the second switching cycle.

The current values flowing through the first power switches 111 and the second power switches 112 can be measured and the switch current value can be calculated in the switch activation unit 300 or a separately provided circuit or electronic device.

The switching operation control unit 200 and the switch activation unit 300 may be implemented directly by hardware, a software module executed by hardware or a combination thereof. The software module may be located in a random access memory (RAM), a read only memory (ROM), an erasable programmable ROM (EPROM), an electrically erasable programmable ROM (EEPROM), a flash memory, a hard disk, a removable disk, a CD-ROM or any type of computer-readable recording medium well known in the art.

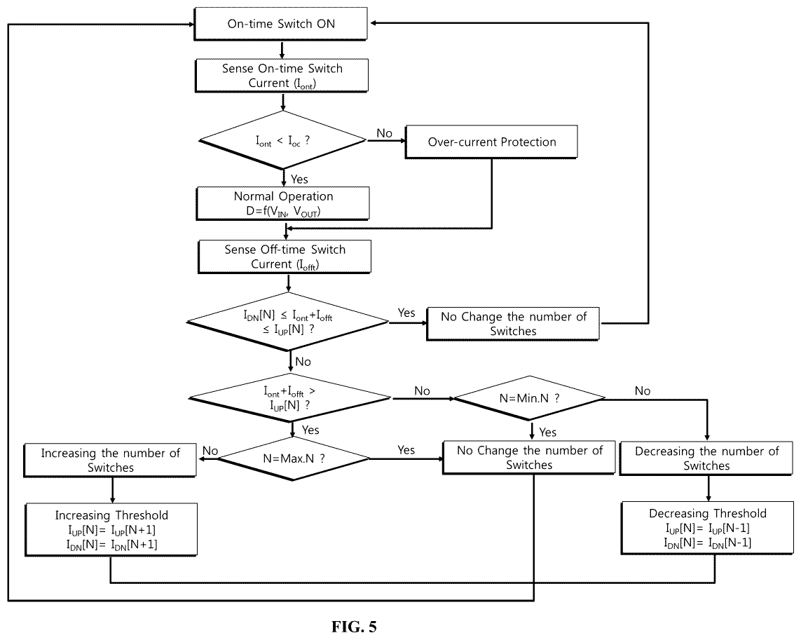

FIG. 5 is a flowchart illustrating the operation of the DC/DC converter of the present invention. With reference to FIG. 5, a description will be given regarding an example of the operation of the DC/DC converter.

The first power switches operate as on-time switches and the second power switches operate as off-time switches. The first power switches are first turned ON to perform a first switching cycle. At this time, the second power switches are turned OFF. A first current value (Iₒₙₜ) flowing through the turned-on first power switches is measured and compared with an over-current threshold (I_{oc}). When the first current value is not lower than the over-current threshold, the first and second power switches are immediately turned OFF and ON, respectively, by over-current protection. Meanwhile, when the first current value is lower than the over-current threshold, a normal switching operation is performed according to the duty ratio of an input voltage and an output voltage.

When the second power switches are turned ON and the first power switches are turned OFF under over-current protection or a normal switching operation according to the duty ratio, a second current value (I_{offt}) flowing through the second power switches is measured. Next, the first current value and the second current value are summed to calculate a switch current value (Iₒₙₜ+I_{offt}) and a determination is made as to whether the switch current value is not higher than a first threshold (I_{UP}) and is not lower than a second threshold (I_{DN}).

When the switch current value is not lower than the second threshold and is higher than the first threshold, a second switching cycle is performed in a state in which the number of the switch strings, that is, the number of the first and second power switches, is maintained.

When the switch current value exceeds the first threshold, it is first determined whether the number of the switch strings operating in a first switching cycle is maximum. The maximum number of the switch strings indicates the number of the switch strings originally provided in the DC/DC converter. When the number of the switch strings is maximum, a second switching cycle is performed in a state in which the number of the switch strings, that is, the number of the first and second power switches, is maintained. If the number of the switch strings does not reach the maximum, which corresponds to heavy load conditions, the number of the switch strings is increased to perform a second switching cycle. At this time, only one switch string may be increased. The first threshold may be increased to set a third threshold, which may be applied to the second switching cycle.

Meanwhile, when the switch current value is less than the second threshold, it is first determined whether only one switch string operates in a first switching cycle. When only one switch string operates, a second switching cycle is performed in a state in which the one switch string is maintained. If the number of the switch strings is two or more, which corresponds to light load conditions, a second switching cycle is performed in which the number of the switch strings is decreased. At this time, only one switch string may be decreased. The second threshold may be reduced to set a fourth threshold, which may be applied to the second switching cycle. The first to fourth thresholds, which are criteria for determining the number of the switch strings, may be preset depending on the number of the operating switch strings, that is, the first and second power switches.

The above operations are implemented by the switch activation unit, but the first and/or second current values may also be measured by a separate current measuring circuit (not illustrated).

The efficiency of the DC/DC converter according to the present invention is improved compared to that of a conventional DC/DC converter, which will be described below.

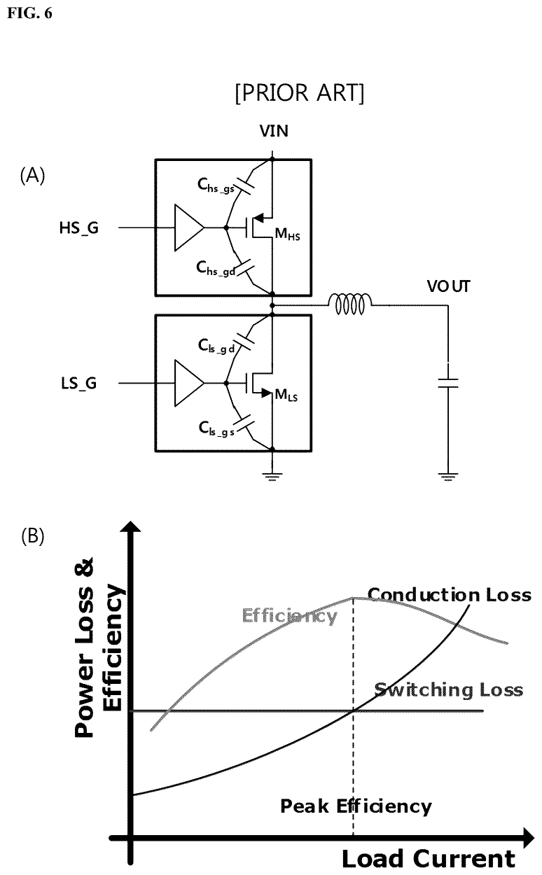

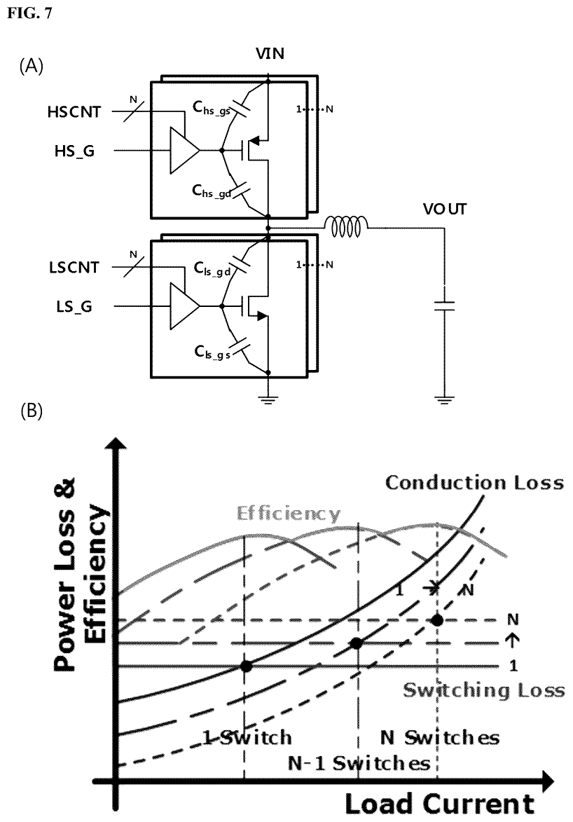

FIG. 6 illustrates (A) a conventional buck converter and shows (B) power loss and efficiency of the conventional buck converter depending on load current and FIG. 7 illustrates (A) the DC/DC converter of the present invention and shows (B) power loss and efficiency of the DC/DC converter depending on load current.

As illustrated in FIG. 6, the conventional buck converter controls an output voltage by switching operations of two power switches, that is, a high-side MOSFET (MHS) and a low-side MOSFET (MLS). The total gate capacitances (C_{TOTAL}) of the high-side MOSFET and the low-side MOSFET at fixed pulse widths are C_{hs_gs}+C_{hs_gd} and C_{is_gs}+C_{is_gd}, respectively. Switching loss is caused by switching operations where the high-side MOSFET and the low-side MOSFET are alternately turned ON and OFF. Since switching loss is more responsible for power loss than conduction loss under light load conditions, increased efficiency can be expected when switching loss is reduced under light load conditions. However, power switches whose device size is determined have limitations in reducing switching loss because their total gate capacitance is fixed.

In contrast, with reference to FIG. 7, although the DC/DC converter of the present invention is the same in size as the conventional device because each of the N first and second power switches has a size of 1/N, it can achieve maximum efficiency by varying the number of the power switches depending on load conditions. Under a certain load current, conduction loss decreases and switching loss increases with increasing number of power switches, and vice versa. Since the load current is high under heavy load conditions, conduction loss is a dominant factor. Therefore, the DC/DC converter of the present invention uses an increased number of power switches under heavy load conditions to reduce conduction loss, which constitutes a large portion of power loss, despite an increase in switching loss, achieving maximum efficiency. Since the load current is low under light load conditions, switching loss is a dominant factor. Therefore, the DC/DC converter of the present invention uses a decreased number of power switches under light load conditions to reduce switching loss, which constitutes a large portion of power loss, achieving maximum efficiency. At this time, the gates of the power switches that are not in operation are in high impedance states, and as a result, the total gate capacitance is reduced upon switching operations.

Although the present invention has been described herein with reference to the foregoing specific embodiments, these embodiments do not serve to limit the invention and are set forth for illustrative purposes. It will be apparent to those skilled in the art that modifications and improvements can be made without departing from the spirit and scope of the invention.

Simple modifications and changes of the present invention belong to the scope of the present invention and the specific scope of the present invention will be clearly defined by the appended claims.

What is claimed is:

1. A DC/DC converter designed to boost or step down an input voltage applied to one of a first input/output end and a second input/output end and to output an output voltage through the other input/output end and comprising: a switch unit comprising N (N is a natural number greater than or equal to 2) switch strings, each of which comprises a first power switch and a second power switch alternately turned ON and OFF and connected in series with each other, arranged such that the N first power switches are connected in parallel between the first input/output end and a node and the N second power switches are connected in parallel between the node and a ground end; a switching operation control unit independently controlling switching operations of the first power switches and the second power switches; and a switch activation unit controlling switch activation such that only the switches of K (K is a natural number from 2 to N) ones of the N switch strings are operated based on a switch current value corresponding to the sum of current values flowing through the first power switches and the second power switches in a switching cycle where the first power switches and the second power switches are alternately turned ON and OFF.

2. The DC/DC converter according to claim 1, wherein between a first switching cycle and a second switching cycle that are performed sequentially and continuously, the switch activation unit performs the second switching cycle in which the number of the switching strings whose switches are activated is increased compared to that in the first switching cycle when the switch current value in the first switching cycle exceeds a predetermined first threshold or performs the second switching cycle in which the number of the switching strings whose switches are activated is decreased compared to that in the first switching cycle when the switch current value in the first switching cycle is less than a predetermined second threshold.

3. The DC/DC converter according to claim 2, wherein only one switch string is decreased or increased.

4. The DC/DC converter according to claim 2, wherein when the switch current value in the first switching cycle is not higher than the first threshold and not lower than the second threshold, the second switching cycle is performed in a state in which the number of the switch strings whose switches are activated in the first switching cycle is maintained.

5. The DC/DC converter according to claim 1, wherein each of the first power switches comprises a P-channel MOSFET, each of the second power switches comprises an N-channel MOSFET, and the switching operation control unit comprises a gate driver.

6. The DC/DC converter according to claim 1, wherein the switch activation unit is operated in pulse width modulation (PWM) mode.
